(19) United States
(12) Patent Application Publication
(10) Pub. No.: US 2023/0365103 A1
(43) Pub. Date: Nov. 16, 2023

(54) AUTOMOTIVE DEVICE

(71) Applicant: InnoLux Corporation, Miao-Li County (TW)

(72) Inventors: Yuan-San HSIAO, Miao-Li County (TW); Tsan-Po WENG, Miao-Li County (TW)

(21) Appl. No.: 18/300,570

(22) Filed: Apr. 14, 2023

(30) Foreign Application Priority Data
May 16, 2022 (CN) 202210531409.0

(51) Int. Cl. B60R 25/25; G06V 40/16; G06V 40/13; G06V 40/12; G06V 40/70; B60R 25/30

(52) U.S. Cl. CPC B60R 25/252; G06V 40/168; G06V 40/13; G06V 40/1347; G06V 40/70; B60R 25/30; G06V 20/59

(57) ABSTRACT

An automotive device includes a first sensing unit, a second sensing unit and a processing unit. The first sensing unit is used to sense a first biological feature, and generate a first key signal according to the first biological feature. The second sensing unit is used to sense a second biological feature different from the first biological feature, and generate a second key signal according to the second biological feature. The processing unit is electrically connected with the first sensing unit and the second sensing unit. The processing unit receives at least one of the first key signal and the second key signal, and determines whether to unlock the automotive device according to the at least one of the first key signal and the second key signal.

### CROSS-REFERENCE TO RELATED APPLICATIONS

This application claims the benefits of the Chinese Patent Application Serial Number 202210531409.0, filed on May 16, 2022, the subject matter of which is incorporated herein by reference.

### BACKGROUND

### Field of Disclosure

The present disclosure relates to an automotive device and, more particularly, to an automotive device with sensing components.

### Description of Related Art

At present, the function of the automotive host computer becomes increasingly powerful, and may be integrated with many smart applications, such as finance, medical treatment, shopping, and multimedia services. Typically, these smart applications may involve the information security of the user. Therefore, the user usually has to pass the identity verification before gaining the permissions of these applications. However, during the driving process, the user has to pay attention on driving the automobile, and thus is unable to manually enter the password or perform complicated identity recognition processes.

Therefore, there is an urgent need to provide an improved automotive device to mitigate and/or obviate the aforementioned problems.

### SUMMARY

The present disclosure relates to an automotive device, which includes a first sensing unit, a second sensing unit and a processing unit. The first sensing unit is used for sensing a first biological feature and generating a first key signal according to the first biological feature. The second sensing unit is used for sensing a second biological feature and generating a second key signal according to the second biological feature. The second biological feature is different from the first biological feature. The processing unit is electrically connected to the first sensing unit and the second sensing unit. The processing unit receives at least one of the first key signal and the second key signal, and determines whether to unlock the automotive device according to the at least one of the first key signal and the second key signal.

Other novel features of the disclosure will become more apparent from the following detailed description when taken in conjunction with the accompanying drawings.

### BRIEF DESCRIPTION OF DRAWINGS

FIG. 1 is a schematic diagram of the automotive device according to one embodiment of the present disclosure;

FIG. 2 is a schematic diagram illustrating the detailed structure of a first sensing unit, a second sensing unit and a processing unit according to an embodiment of the present disclosure;

FIG. 3 is a flowchart illustrating the steps of a recognition procedure of the automotive device according to one embodiment of the present disclosure;

FIG. 4 is a flowchart illustrating the steps of a recognition procedure of the automotive device according to another embodiment of the present disclosure;

FIG. 5 is a schematic diagram of the automotive device according to another embodiment of the present disclosure;

FIG. 6 is a schematic diagram of the automotive device according to another embodiment of the present disclosure;

FIG. 7 is a schematic diagram of the automotive device according to another embodiment of the present disclosure; and

FIG. 8 is a functional block diagram of the automotive device according to an embodiment of the present disclosure..

### DETAILED DESCRIPTION OF EMBODIMENT

The implementation of the present disclosure is illustrated by specific embodiments to enable persons skilled in the art to easily understand the other advantages and effects of the present disclosure by referring to the disclosure contained therein. The present disclosure is implemented or applied by other different, specific embodiments. Various modifications and changes can be made in accordance with different viewpoints and applications to details disclosed herein without departing from the spirit of the present disclosure.

It is noted that, in the specification and claims, unless otherwise specified, having “one” element is not limited to having a single said element, but one or more said elements may be provided. In addition, the description of at least one of the element “a” and the element “b” includes an aspect with only the element “a”, an aspect with only the element “b”, and an aspect with both the element “a” and the element “b”.

In addition, in the specification and claims, unless otherwise specified, ordinal numbers, such as “first” and “second”, used herein are intended to distinguish components rather than disclose explicitly or implicitly that names of the components bear the wording of the ordinal numbers. The ordinal numbers do not imply what order a component and another component are in terms of space, time or steps of a manufacturing method. These ordinal numbers are used only to distinguish one element with a particular name from another element with the same name.

In addition, the term “adjacent” used herein may refer to describe mutual proximity and does not necessarily mean mutual contact.

In addition, the description of “when . . . ” or “while . . . ” in the present disclosure means “now, before, or after”, etc., and is not limited to occurrence at the same time. In the present disclosure, the similar description of “disposed on” or the like refers to the corresponding positional relationship between the two components, and does not limit whether there is contact between the two components, unless specifically limited. Furthermore, when the present disclosure recites multiple effects, if the word “or” is used between the effects, it means that the effects can exist independently, but it does not exclude that multiple effects can exist at the same time.

In addition, the terms “connect” or “couple” in the specification and claims not only refer to direct connection with another component, but also indirect connection with another component, or refer to electrical connection. Besides, the electrical connection may include a direct connection, an indirect connection, or a mode in which two components communicate through radio signals.

In addition, in the specification and claims, the term “almost”, “about”, “approximately” or “substantially” usually means within 20%, 10%, 5%, 3%, 2%, 1% or 0.5% of a given value or range. The quantity the given value is an approximate quantity, which means that the meaning of “almost”, “about”, “approximately” or “substantially” may still be implied in the absence of a specific description of “almost”, “about”, “approximately” or “substantially”. In addition, the terms “ranging from the first value to the second value” and “range between the first value and the second value” indicate that the range includes the first value, the second value, and other values between the first value and the second value.

For convenience of description, the term “in a direction” hereinafter may represent “substantially in the direction” or “substantially in a direction opposite to the direction”, while it is not limited thereto. In addition, there may be a deviation within about 60 degrees (≤60°) between the actual direction and the said direction, but it is not limited thereto.

In addition, the technical features of different embodiments disclosed in the present disclosure may be combined to form another embodiment.

In addition, the present disclosure claims an electronic device with electronic components, which may include, for example, an automotive device, a wafer or wafer test workstation, a test device, a cleaning device, a foreign object removal device, a display device, a backlight device, an antenna device, a sensing device, a tiled device, a touch display, a curved display or a free shape display, or a combination thereof, but not limited thereto. The electronic device may include, for example, liquid crystal, light emitting diode, fluorescence, phosphor, other suitable display media, or a combination thereof, but not limited thereto. The electronic device may include, for example, liquid crystal, light emitting diode, fluorescence, phosphor, other suitable display media, or a combination thereof, but is not limited thereto. The light emitting diode may include, for example, an organic light emitting diode (OLED), a sub-millimeter light emitting diode (mini LED), a micro light emitting diode (micro LED) or a quantum dot (QD) light emitting diode (for example, QLED, QDLED) or other suitable materials or a combination thereof, but not limited thereto. The display device may include, for example, a display panel or a touch panel, and may be a non-self-luminous display device or a self-luminous display device. The. The antenna device may be, for example, a liquid crystal antenna or non-liquid crystal antenna, but not limited thereto. The sensing device may be such a sensing device for sensing capacitance, light, thermal energy or ultrasonic waves, but not limited thereto. Electronic components may include passive components and active components, such as capacitors, resistors, inductors, diodes, transistors, etc. The diodes may include light emitting diodes or photodiodes. The light emitting diodes may, for example, include organic light emitting diodes (OLEDs), mini light emitting diodes (mini LEDs), micro light emitting diodes (micro LEDs) or quantum dot light emitting diodes (quantum dot LEDs), but not limited to. The tiled device may be, for example, a tiled display device or a tiled antenna device, but not limited thereto. In addition, the electronic device may be a bendable or flexible electronic device. It should be noted that the electronic device may be a combination of the foregoing, but not limited thereto. In addition, the appearance of the electronic device may be rectangular, circular, polygonal, a shape with curved edges, or other suitable shapes. The electronic device may have peripheral systems such as a driving system, a control system, a light source system, a shelf system, etc., to support a display device, an antenna device, or a tiled device.

For the convenience of description, the electronic device is described hereinafter as an automotive device, but the present disclosure is not limited thereto.

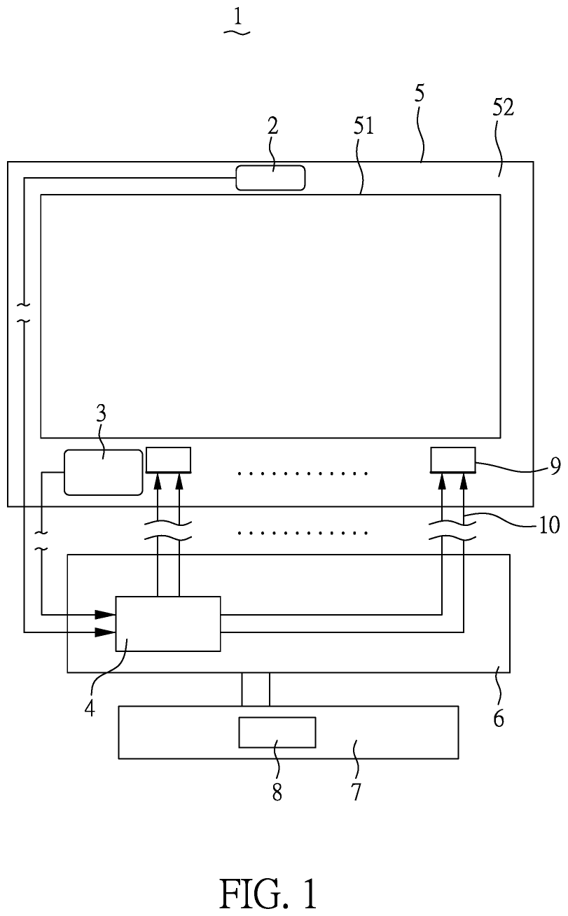

Please refer to FIG. 1, which is a schematic diagram of the automotive device 1 according to one embodiment of the present disclosure.

As shown in FIG. 1, the automotive device 1 includes a first sensing unit 2 , a second sensing unit 3 and a processing unit 4. The first sensing unit 2 is used for sensing a first biological feature, and the second sensing unit 3 is used for sensing a second biological feature, wherein the second biological feature is different from the first biological feature. The processing unit 4 is electrically connected to the first sensing unit 2 and the second sensing unit 3. The first sensing unit 2 can generate a first key signal according to the sensed first biological feature. The second sensing unit 3 can generate a second key signal according to the sensed second biological feature. The processing unit 4 can receive at least one of the first key signal generated by the first sensing unit 2 and the second key signal generated by the second sensing unit 3, and judges whether to unlock the automotive device 1 according to the at least one of the first key signal and the second key signal, wherein the term “at least one of the first key signal and the second key signal” refers to the aspect such as including the first key signal, including the second key signal, or including both the first key signal and the second key signal, and the term “unlock the automotive device” includes the aspect such as activating or waking up the automotive device, unlocking some or all functions of the automotive device, or controlling the automotive device to perform an operation, but it is not limited thereto.

In one embodiment, the automotive device 1 may further include a display device 5 and a circuit board 6. The display device 5 and the circuit board 6 may be electrically connected to each other through signal wires 10. The display device 5 may include a display panel 51, a non-display area 52 and at least one driving chip 9. The display device 5 may be electrically connected with the processing unit 4. Furthermore, the display panel 51 may be electrically connected with the processing unit 4, and may be used for displaying images. The non-display area 52 may be, for example, the peripheral area of the display device 5, but it is not limited thereto. The driving chip 9 may be arranged on the circuit board 6 or the non-display area 52. The driving chip 9 may be used to drive the display panel 51 to operate, such as displaying pictures and the like. The circuit board 6 may be arranged outside the display device 5, but may also be arranged on the non-display area 52 of the display device 5.

In one embodiment, the automotive device 1 may further include an automotive host 7 and a host chip 8. The automotive host 7 may be electrically connected with the circuit board 6. The host chip 8 may be used to control the automotive host 7, wherein the host chip 8 may be arranged inside the automotive host 7, but it is not limited thereto.

In one embodiment, the processing unit 4 may be arranged on the circuit board 6, but it may also be arranged outside the circuit board 6. For example, it may be arranged on the automotive host 7, the non-display area 52 of the display device 5 or other positions of the automotive device 1, but the present disclosure is not limited thereto.

Next, the details of each component will be described. Please refer to FIG. 1 and

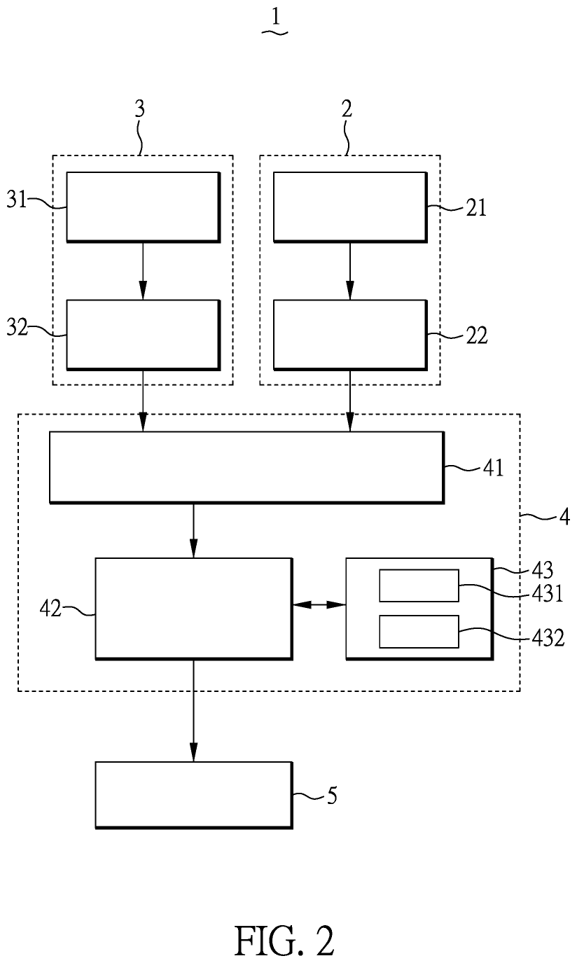

FIG. 2 at the same time, wherein FIG. 2 is a schematic diagram illustrating the detailed structure of a first sensing unit, a second sensing unit and a processing unit according to an embodiment of the present disclosure.

First, the first sensing unit 2 will be described. In one embodiment, the first sensing unit 2 may, for example, have a face recognition function, but it is not limited thereto. For example, as shown in FIG. 2, the first sensing unit 2 for face recognition may include a face recognition unit 21 and a face recognition chip 22 that are electrically connected to each other. The face recognition unit 21 may be used to obtain face features; that is, the first biological feature may include face features. The face recognition chip 22 may control the operation of the face recognition unit 21, or may process the data obtained by the face recognition unit 21, but it is not limited thereto. In one embodiment, the face recognition unit 21 may be, for example, a camera, a video camera or a lens, while it is not limited thereto. The face recognition chip 22 may generate a first key signal according to the face feature obtained by the face recognition unit 21, and transmit the first key signal to the processing unit 4. In one embodiment, the first key signal may include face features, but it is not limited thereto.

In addition, as shown in FIG. 1, the first sensing unit 2 may be arranged outside the display panel 51, for example, may be arranged on the non-display area 52 or outside the display device 5, while it is not limited thereto. In one embodiment, the first sensing unit 2 may be arranged at any position in the automobile, as long as the electrical connection between the first sensing unit 2 and the processing unit 4 can be maintained and the face feature can be sensed. For example, the first sensing unit 2 may be arranged on the steering wheel of the automobile, but it is not limited thereto, so that, when the user is driving the automobile, his/her face may be directly facing the first sensing unit 2 thereby making the sensing more convenient, while it is not limited thereto. In one embodiment, the face recognition unit 21 and the face recognition chip 22 of the first sensing unit 2 may also be arranged separately. For example, the face recognition unit 21 is arranged on the steering wheel of the automobile, and the face recognition chip 22 is arranged on the non-display area 52 or other suitable positions in the automobile, while it is not limited thereto.

Next, the second sensing unit 3 will be described. In one embodiment, the second sensing unit 3 may, for example, have a fingerprint recognition function, but it is not limited thereto. For example, as shown in FIG. 2, the second sensing unit 3 for fingerprint recognition may include a fingerprint recognition unit 31 and a fingerprint recognition chip 32 that are electrically connected to each other. The fingerprint recognition unit 31 is used to obtain fingerprint features; that is, the second biological feature may include the fingerprint features. The fingerprint recognition chip 32 may control the operation of the fingerprint recognition unit 31, or may process the data obtained by the fingerprint recognition unit 31, but it is not limited thereto. In one embodiment, the fingerprint recognition unit 31 may be, for example, a fingerprint sensor, and its sensing principle may include optical reflection, capacitive sensing, or biological radio frequency sensing, etc., while it is not limited thereto. The fingerprint recognition chip 32 may generate a second key signal according to the fingerprint features obtained by the fingerprint recognition unit 31, and transmit the second key signal to the processing unit 4. In one embodiment, the second key signal may include fingerprint features, but it is not limited thereto.

In addition, as shown in FIG. 1, the second sensing unit 3 may be arranged outside the display panel 51, for example, may be arranged on the non-display area 52 or outside the display device 5, while it is not limited thereto. In one embodiment, the second sensing unit 3 may be arranged at any position in the automobile, as long as the electrical connection between the second sensing unit 3 and the processing unit 4 can be maintained, and the fingerprint features can be sensed. For example, the second sensing unit 3 may be arranged on the steering wheel, gear lever, hand brake or other control buttons of the automobile, while it is not limited thereto, so that the user may easily touch the second sensing unit with his/her fingers when driving the automobile thereby making the sensing more convenient, while it is not limited thereto. In one embodiment, the fingerprint recognition unit 31 and the fingerprint recognition chip 32 of the second sensing unit 3 may also be arranged separately. For example, the fingerprint recognition unit 31 is arranged on the steering wheel of the automobile, and the fingerprint recognition chip 32 is arranged on the non-display area 52 or other suitable positions in the automobile, while it is not limited thereto.

In addition, in other embodiments, the first sensing unit 2 and the second sensing unit 3 may also be other types of biological sensors, such as gesture recognition device, voice recognition device, iris recognition device or other physiological signal recognitio devices, etc., but it is not limited thereto. In addition, the type of the first sensing unit 2 is different from the type of the second sensing unit 3.

Next, the processing unit 4 will be described. The type of the processing unit 4 may include SoC (System on a Chip) chip integration or SIP (System In Package) chip integration, but it is not limited thereto.

As shown in FIG. 2, in one embodiment, the processing unit 4 may include a communication interface module 41, a processing component 42, and an access component 43 that are electrically connected to each other. In one embodiment, the type of the communication interface module 41 may include serial peripheral interface (SPI), universal asynchronous receiver/transmitter (UART) or inter-integrated circuit bus (I2C) etc., but it is not limited thereto. In one embodiment, the type of the processing component 42 may include a processor, a microprocessor, or a microcontroller, etc., while it is not limited thereto. In one embodiment, the type of the access component 43 may be, for example, a memory, while it is not limited thereto.

The communication interface module 41 may receive the first key signal from the first sensing unit 2 and the second key signal from the second sensing unit 3, and may convert the first key signal and the second key signal into the signal format applicable to the processing component 42, for example, converting an analog signal format into a digital signal format, but it is not limited thereto.

The access component 43 may store at least one first keyhole information and at least one second keyhole information. In one embodiment, the access component 43 may include an authentication database storing keyhole information, wherein the number of the authentication database may be one or more, for example. In addition, the corresponding relationship between the number of keyhole information and the number of authentication databases may be, for example, one keyhole information corresponds to one authentication database, or multiple keyhole information correspond to one authentication database, but it is not limited thereto. As shown in FIG. 2, the access component 43 may include, for example, a first authentication database 431 and a second authentication database 432, wherein the first authentication database 431 may store at least one first keyhole information or multiple first keyhole information, the second authentication database 432 may store at least one second keyhole information or multiple second keyhole information. In one embodiment, the access component 43 may, for example, have an authentication database, and the authentication database stores at least one first keyhole information and at least one second keyhole information, but it is not limited thereto. In one embodiment, the first keyhole information may include, for example, a first biological feature preset by the user through the processing component 42, such as a preset face feature. In one embodiment, the second keyhole information may include, for example, a second biological feature preset by the user through the processing component 42, such as a preset fingerprint feature, while it is not limited thereto.

The processing component 42 may be used for identity setting and identity recognition. In one embodiment, the processing component 42 may execute a recognition procedure to identify the first key signal or the second key signal, wherein the recognition procedure may be implemented, for example, by a computer program product, and the computer program product may have multiple instructions to drive the processing component 42 to perform special operations. For example, the processing component 42 may perform comparison to determine whether the first key signal is the same as the first keyhole information in the first authentication database 431 so as to determine whether the sensed first biological feature is correct (that is, whether it conforms to the first biological feature preset by the user), or perform comparison to determine whether the second key signal is the same as the second keyhole information in the second authentication database 432 so as to determine whether the sensed second biological feature is correct (that is, whether it conforms to the second biological feature preset by the user). The recognition procedure of the processing component 42 will be described in more detail in the subsequent paragraphs.

Next, the display device 5 will be described. In one embodiment, the display device 5 may be provided with a touch function, and may be used as a human-machine interaction interface for the automobile host 7, so the user may issue commands to the automobile host 7 through the display panel 51, but it is not limited thereto. In addition, as shown in FIG. 1 and FIG. 2, in one embodiment, when the processing unit 4 determines to unlock the automotive device 1, the processing unit 4 may send a message to the driving chip 9, so that the driving chip 9 drives the display panel 51, and unlock the automotive device 1. In some embodiments, after the driving chip 9 drives the display panel, an unlocking symbol may be displayed to remind the user that the automotive device 1 has been unlocked, but it is not limited thereto.

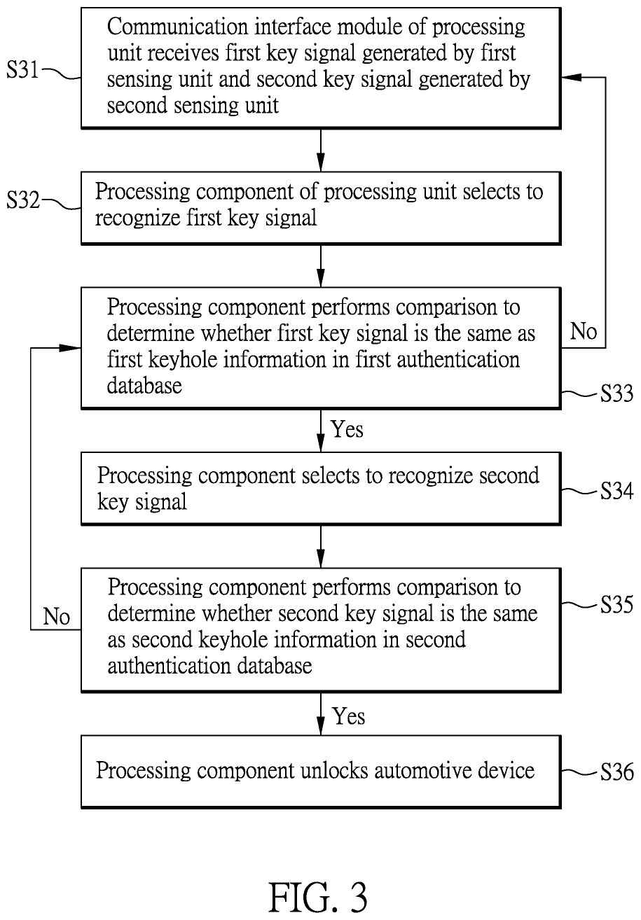

Next, the process of the recognition procedure executed by the processing component 42 will be described. Please refer to FIG. 1 to FIG. 3 at the same time, wherein FIG. 3 is a flowchart illustrating the steps of the recognition procedure of the automotive device according to one embodiment of the present disclosure.

As shown in FIG. 3, step S31 is executed first, in which the first sensing unit 2 senses the first biological feature, the second sensing unit 3 senses the second biological feature, and the communication interface module 41 of the processing unit 4 receives the first key signal generated by the first sensing unit 2 and the second key signal generated by the second sensing unit 3. Then, step S32 is executed, in which the processing component 42 of the processing unit 4 selects to recognize the first key signal. Then, step S33 is executed, in which the processing component 42 performs comparison to determine whether the first key signal is the same as the first keyhole information in the first authentication database 431. When the first key signal is different from the first keyhole information, the processing unit 4 re-executes step S31 (or the processing unit 4 may also be set to stop operation). When the first key signal is the same as the first keyhole information, step S34 is executed, in which the processing component 42 selects to recognize the second key signal. Then, step S35 is executed, in which the processing component 42 performs comparison to determine whether the second key signal is the same as the second keyhole information in the second authentication database 432. When the second key signal is different from the second keyhole information, the processing unit 4 re-executes step S33 (or the processing unit 4 may also be set to stop operation or re-execute step S31). When the second key signal is the same as the second keyhole information, step S36 is executed, in which the processing component 42 unlocks the automotive device 1.

Regarding step S31, in one embodiment, the automotive device 1 may be set such that, when the user activates the automotive host 7 or operates the automotive host 7 to perform certain functions, the first sensing unit 2 and the second sensing unit 3 will be activated to obtain the first biological feature and the second biological feature, respectively, while it is not limited thereto. In one embodiment, the automotive device 1 may also be set to periodically activate the first sensing unit 2 and the second sensing unit 3 to obtain the first biological feature and the second biological feature.

Regarding step S32, although this example uses the processing unit 4 to first perform recognition on the first key signal (face recognition), it actually may also be set to first perform recognition on the second key signal (fingerprint recognition). Alternatively, it may also be set to first perform recognition on the signal obtained earlier; for example, when the second key signal is obtained first, the recognition of the second key signal is performed first, and vice versa.

In addition, as seen in steps S33 to S36, the processing unit 4 of this embodiment is set to unlock the automotive device 1 only when the first key signal and the second key signal are recognized successfully. Therefore, the information security can be effectively improved. As a result, the recognition procedure of the embodiment shown in FIG. 3 can be completed.

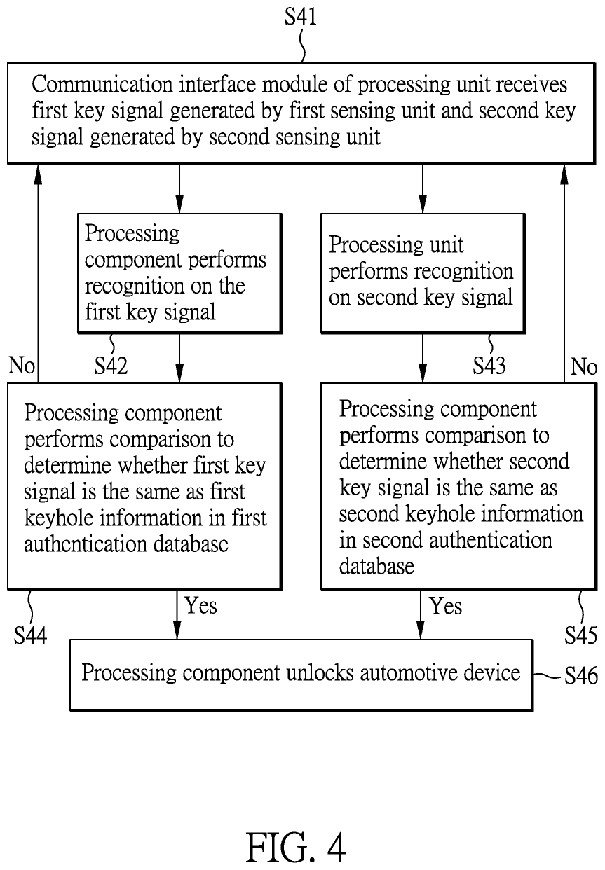

FIG. 4 is a flowchart illustrating the steps of a recognition procedure of the automotive device according to another embodiment of the present disclosure, and please refer to FIG. 1 to FIG. 3 at the same time.

As shown in FIG. 4, step S41 is executed first, in which the first sensing unit 2 senses the first biological feature, the second sensing unit 3 senses the second biological feature, and the communication interface module 41 of the processing unit 4 receives the first key signal generated by the first sensing unit 2 and the second key signal generated by the second sensing unit 3. Then step S42 is executed, in which the processing component 42 performs recognition on the first key signal. In addition, step S43 may also be executed, in which the processing unit 4 performs recognition on the second key signal. After step S42 is completed, step S44 is executed, in which the processing component 42 performs comparison to determine whether the first key signal is the same as the first keyhole information in the first authentication database 431. In addition, after step S43 is completed, step S45 is executed, in which the processing component 42 performs comparison to determine whether the second key signal is the same as the second keyhole information in the second authentication database 432. If the first key signal is different from the first keyhole information, and the second key signal is different from the second keyhole information, step S41 is re-executed or the processing unit 4 stops operation. If the first key signal is the same as the first keyhole information or the second key signal is the same as the second keyhole information, step S46 is executed to unlock the automotive device 1. Some steps in the embodiment of FIG. 4 may be known by referring to the embodiment of FIG. 3, and thus a detailed description for these steps is deemed unnecessary.

Compared with the embodiment of FIG. 3, the embodiment of FIG. 4 may perform recognition on the first key signal and the second key signal in synchronization, wherein “synchronization” means that there is no need to wait for the recognition of one of the two to be completed before starting recognition of the other. Therefore, the processing unit 4 may be set so that, when at least one of the first key signal and the second key signal is recognized successfully (that is, the first key signal is the same as the first keyhole information, or the second key signal is the same as the second keyhole information); that is, the automotive device 1 is unlocked. However, in another embodiment, the processing unit 4 may also be set so that, when the first key signal and the second key signal are both successfully recognized (that is, the first key signal is the same as the first keyhole information, and the second key signal is the same as the second keyhole information), the automotive device 1 will be unlocked. In other words, as long as one of the recognitions fails, the processing unit 4 will re-execute step S41 or stop operation, thereby effectively improving the security of information. As a result, the recognition procedure of the embodiment in FIG. 4 may be understood.

In addition, the first sensing unit 2 and the second sensing unit 3 may also have different configurations, which will be described below.

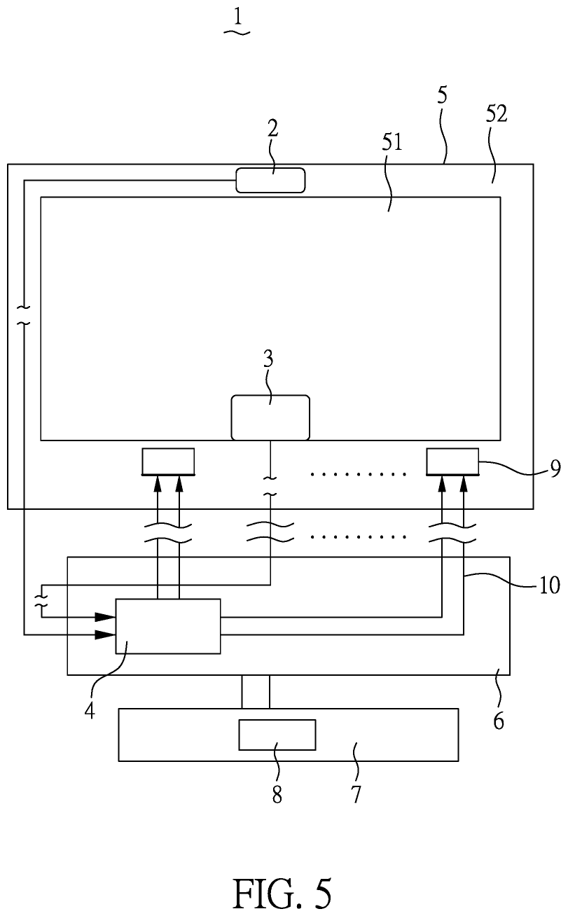

FIG. 5 is a schematic diagram of the automotive device 1 according to another embodiment of the present disclosure, and please refer to FIG. 1 at the same time, wherein some features of the embodiment in FIG. 5 can be known from the description of the embodiment in FIG. 1, and only the difference is described in the following.

In the embodiment of FIG. 5, the first sensing unit 2 may be arranged outside the display panel 51, such as but not limited to the steering wheel, gear lever, hand brake or other control buttons. In addition, the second sensing unit 3 and the display panel 51 may be overlapped in the display direction of the display panel 51; that is, the second sensing unit 3 may be arranged inside the display panel 51 or right above the display panel 51.

For example, when the second sensing unit 3 is a fingerprint sensor, the user may perform fingerprint recognition by touching the display panel 51.

In addition, in other embodiments, the aforementioned configuration may also be changed into the first sensing unit 2 and the display panel 51 being overlapped in the display direction, and the second sensing unit 3 being arranged outside the display panel 51.

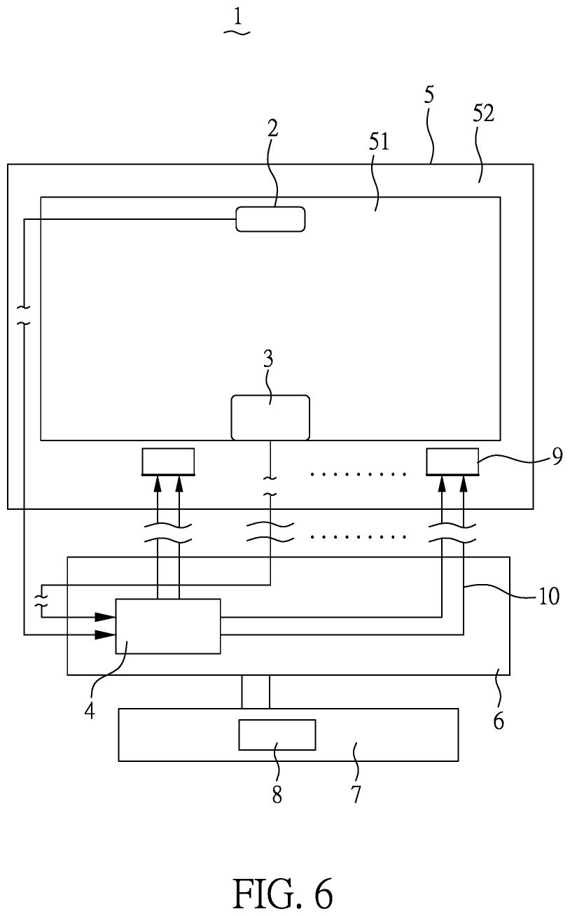

FIG. 6 is a schematic diagram of the automotive device 1 according to another embodiment of the present disclosure, and please refer to FIG. 1 at the same time, wherein most of the features of the embodiment in FIG. 6 can be known from the description of the embodiment in FIG. 1, and only the difference is described in the following.

In the embodiment of FIG. 6, both the first sensing unit 2 and the second sensing unit 3 are overlapped with the display panel 51 in the display direction; that is, the first sensing unit 2 and the second sensing unit 3 may be all arranged inside the display panel 51 or right above the display panel 51. With the design of integrating the first sensing unit 2 and the second sensing unit 3 in the display panel 51, the area of the non-display area 52 may be reduced to save the space for component arrangement on the automobile. In some embodiments, with the design of integrating the first sensing unit 2 and the second sensing unit 3 into the display panel 51, the reduced area of the non-display area 52 may be further converted into the area of the display panel 51, so that the display panel has a larger display screen, or better viewing effect. In addition, in this embodiment, the type of the display panel 51 may include a micro LED display panel, but it is not limited thereto.

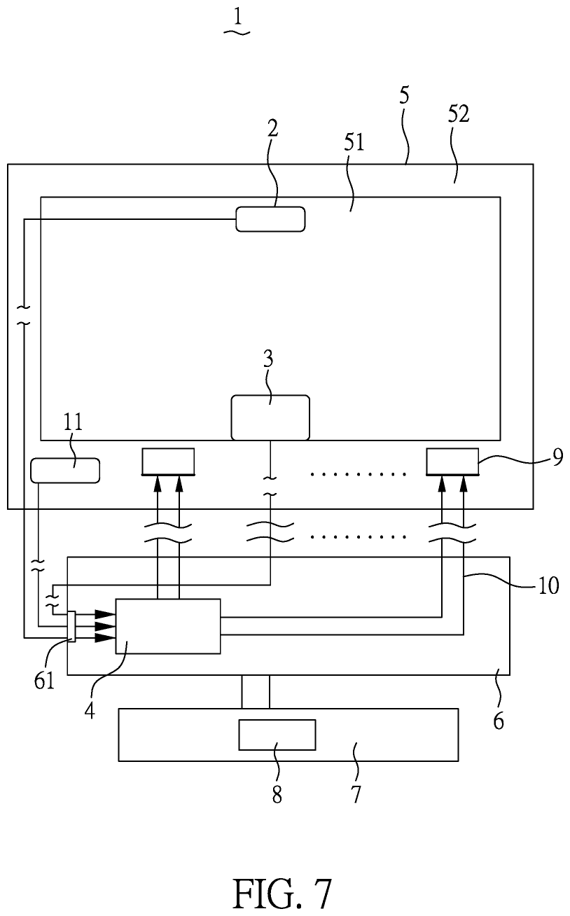

FIG. 7 is a schematic diagram of the automotive device according to another embodiment of the present disclosure, and please refer to FIG. 1 at the same time, wherein most of the features of the embodiment in FIG. 7 can be known from the description of the embodiment in FIG. 1, and only the difference is described in the following.

As shown in FIG. 7, the automotive device 1 further includes a third sensing unit 11 electrically connected to the processing unit 4. The third sensing unit 11 may be arranged outside the display panel 51, but may also be overlapped with the display panel 51 in the display direction, that is, arranged inside or right above the display panel 51.

In one embodiment, the type of the third sensing unit 11 may include an antenna unit, wherein the type of the antenna unit may include a millimeter wave antenna for transmitting millimeter wave radar. With the millimeter-wave radar, the third sensing unit 11 may realize the auxiliary recognition function of vital signs, such as detecting whether there is a person in the automobile, detecting whether driver is tired, or detecting the physical condition, such as heartbeat and so on, of the driver, while it is not limited thereto. In addition, the third sensing unit 11 may provide the function of connecting to a wireless network, and may instantly transmit the detection result of the auxiliary recognition of vital signs to an electronic device outside the automotive device 1, such as a computer in a hospital, while the present disclosure is not limited thereto.

In addition, although the first sensing unit 2 and the second sensing unit 3 in the embodiment of FIG. 7 are overlapped with the display panel 51 in the display direction, in other embodiments having the third sensing unit 11, the first sensing unit 2 or the second sensing unit 3 may also be arranged outside the display panel 51.

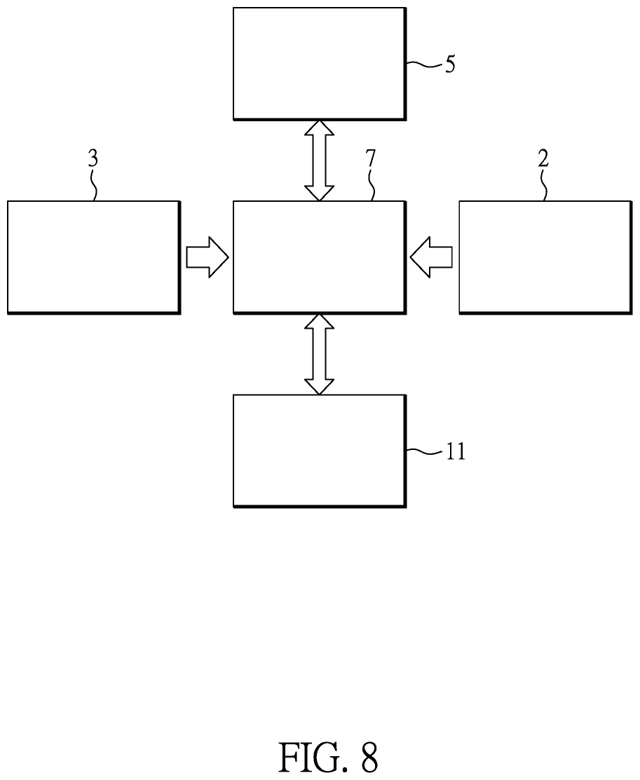

FIG. 8 is a functional block diagram of the automotive device 1 according to an embodiment of the present disclosure, and please refer to FIG. 1 to FIG. 7 at the same time.

As shown in FIG. 1 and FIG. 8, the automotive host 7 of the automotive device 1 may be electrically connected to at least one functional module to expand its functions, for example, electrically connected to the face recognition module (the first sensing unit 2) to have the function of face recognition or, for example, electrically connected to the fingerprint recognition module (second sensing unit 3) to have the function of fingerprint recognition or, for example, electrically connected to the antenna module (the third sensing unit 11) to have the functions of auxiliary recognition of vital signs and wireless communication. In addition, these functional modules (first sensing unit 2, second sensing unit 3 and third sensing unit 11) may be all integrated and presented on the display panel 51 of the automotive device 1 to reduce the number of required components.

The aforementioned steps are just examples. As long as it is reasonable, the order of the steps may be adjusted according to the requirements, or the number of the aforementioned steps may be increased or decreased according to the requirements.

As a result, the details of the automotive device 1 may be understood.

In one embodiment, the present disclosure at least may be used as proof of whether the object falls within the protection scope of the patent by comparing the presence or absence of components in the automotive device 1 and/or the configuration of the components, and is not limited thereto.

As a result, the automotive device 1 of the present disclosure may allow the user to perform recognition easily, even when driving. Alternatively, through multiple biological recognitions, the information security may be enhanced. Alternatively, the display panel 51 of the automotive device 1 may be integrated with multiple functional modules to improve the functions of the automotive host 7 or to save component costs.

The details or features of the various embodiments disclosed in this disclosure may be mixed and matched arbitrarily as long as they do not violate or conflict the spirit of the disclosure.

The aforementioned specific embodiments should be construed as merely illustrative, and not limiting the rest of the present disclosure in any way.

1. An automotive device comprising:
a first sensing unit for sensing a first biological feature and generating a first key signal according to the first biological feature;
a second sensing unit for sensing a second biological feature and generating a second key signal according to the second biological feature, wherein the second biological feature is different from the first biological feature; and
a processing unit electrically connected to the first sensing unit and the second sensing unit,
wherein the processing unit receives at least one of the first key signal and the second key signal, and determines whether to unlock the automotive device according to the at least one of the first key signal and the second key signal.

2. The automotive device as claimed in claim 1, further comprising a display panel electrically connected to the processing unit.

3. The automotive device as claimed in claim 2, wherein the first sensing unit is arranged outside the display panel, and the second sensing unit is overlapped with the display panel.

4. The automotive device as claimed in claim 2, wherein the first sensing unit and the second sensing unit are overlapped with the display panel.

5. The automotive device as claimed in claim 1, further comprising a third sensing unit electrically connected to the processing unit.

6. The automotive device as claimed in claim 5, wherein the third sensing unit is overlapped with the display panel.

7. The automotive device as claimed in claim 5, wherein the third sensing unit is arranged outside the display panel.

8. The automotive device as claimed in claim 1, wherein the first sensing unit includes a face recognition unit, and the second sensing unit includes a fingerprint recognition unit.

9. The automotive device as claimed in claim 1, wherein the processing unit further includes a communication interface module, a processing component and an access component, the access component stores a first keyhole information and a second keyhole information, the communication interface module receives at least one of the first key signal generated by the first sensing unit and the second key signal generated by the second sensing unit, and the processing component performs comparison to determine whether the first key signal is the same as the first keyhole information or whether the second key signal is the same as the second keyhole information to determine whether to unlock the automotive device.

10. The automotive device as claimed in claim 9, further comprising a display panel and a driving chip, wherein, when the first key signal is the same as the first keyhole information or the second key signal is the same as the second keyhole information, the processing unit sends a message to the driving chip, so that the driving chip drives the display panel.

11. The automotive device as claimed in claim 10, wherein an unlocking symbol is displayed after the driving chip drives the display panel.

12. The automotive device as claimed in claim 1, further comprising a circuit board arranged thereon the processing unit.

13. The automotive device as claimed in claim 2, wherein the first sensing unit is overlapped with the display panel, and the second sensing unit is disposed outside the display panel.

14. The automotive device as claimed in claim 5, wherein the third sensing unit includes an antenna unit.

15. The automotive device as claimed in claim 8, wherein the first sensing unit further includes a face recognition chip electrically connected to the face recognition unit.

16. The automotive device as claimed in claim 15, wherein the face recognition chip generates the first key signal according to face features obtained by the face recognition unit.

17. The automotive device as claimed in claim 8, wherein the second sensing unit further includes a fingerprint recognition chip electrically connected to the fingerprint recognition unit.

18. The automotive device as claimed in claim 17, wherein the fingerprint recognition chip generates the second key signal according to fingerprint features obtained by the fingerprint recognition unit.

19. The automotive device as claimed in claim 9, wherein the communication interface module converts the first key signal and the second key signal into a signal format applicable to the processing component.

20. The automotive device as claimed in claim 9, wherein the first keyhole information includes the first biological feature preset through the processing component, and the second keyhole information includes the second biological feature preset through the processing component.
